(19) United States
(12) Patent Application Publication
(10) Pub. No.: US 2014/0191096 A1
(43) Pub. Date: Jul. 10, 2014

(54) MAGNETIC DEVICE MOUNT

(71) Applicant: GARMIN SWITZERLAND GMBH, Schaffhausen (CH)

(72) Inventors: Justin D. Wiercinski, Kansas City, MO (US); Benjamin E. Morrill, Overland Park, KS (US); Derrick D. Lenz, Olathe, KS (US); Warren R. Stevens, Olathe, MO (US)

(73) Assignee: GARMIN SWITZERLAND GMBH, Schaffhausen (CH)

(21) Appl. No.: 13/734,687

(22) Filed: Jan. 4, 2013

(51) Int. Cl. F16M 13/02

(52) U.S. Cl. CPC F16M 13/022
USPC 248/206.5

(57) ABSTRACT

A mounting system for mounting a personal navigation device to a surface comprises a base assembly, a socket, and a mounting coupler. The base assembly includes a base, a mounting ball, and an arm connecting the base to the mounting ball. The socket may be integrated in the personal navigation device and includes spaced apart first and second magnets. The mounting coupler may attach to the mounting ball of the base assembly and removably couple with the socket of the personal navigation device. The mounting coupler may include a body and spaced apart first and second magnets. The body may include a forward wall configured to couple with the personal navigation device and a rear wall configured to couple with the base assembly. The magnets may be aligned with the magnets of the personal navigation device to ensure proper orientation of the personal navigation device on the mounting coupler.

### BACKGROUND

Users of personal navigation devices and other electronic devices often desire to support the devices on vehicle dashboards, windshields or other surfaces so the devices can be easily viewed and used while driving. Various types of mounts have been developed for this purpose.

### SUMMARY

Embodiments of the present technology provide a mounting system for mounting a personal navigation device or other electronic device to a dashboard or other surface. An embodiment of the system broadly comprises a base assembly, a socket, and a mounting coupler.

The base assembly may include a base, a mounting ball, and an arm connecting the base to the mounting ball. The socket may be integrated in a housing of the personal navigation device and includes a mounting surface and spaced apart first and second magnets positioned opposite the mounting surface and oriented such that the poles of the first magnet oppose the poles of the second magnet.

The mounting coupler attaches to the mounting ball of the base assembly and removably couples with the socket of the personal navigation device. An embodiment of the mounting coupler may include a body, an electrical connector, a cable port, and spaced apart first and second magnets. The body may include a forward wall configured to couple with the personal navigation device and a rear wall configured to couple with the base assembly. The electrical connector may be positioned on the forward wall and configured to couple with a communication port on the personal navigation device when the personal navigation device is connected to the mounting coupler. The cable port may be configured to receive an electrical cable such that electrical connection is provided between the cable and the connector.

The magnets may be positioned adjacent to an inner surface of the forward wall and oriented such that the first magnet of the mounting coupler attracts the first magnet of the socket and repels the second magnet of the socket. Likewise, the second magnet of the mounting coupler attracts the second magnet of the socket and repels the first magnet of the socket. This configuration allows the personal navigation device to be quickly and easily attached to the mounting coupler and ensures proper orientation of the personal navigation device on the mounting coupler so that the electrical connector of the mounting coupler aligns with the communication port of the personal navigation device.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWING FIGURES

Embodiments of the present technology is described in detail below with reference to the attached drawing figures, wherein:

FIG. 1 is a perspective view of a mounting system for mounting a personal navigation device to a surface, constructed in accordance with various embodiments of the present technology, as seen from the front of the personal navigation device;

FIG. 2 is a perspective view of the mounting system as seen from the rear of the personal navigation device;

FIG. 3 is a partially exploded perspective view of the mounting system as seen from the front of the personal navigation device depicting a forward wall removed from the mounting coupler, and further depicting the interior of the personal navigation device to show the first and second magnets therein;

FIG. 4 is a partially exploded perspective view of the mounting system as seen from the rear of the personal navigation device depicting the forward wall removed from the mounting coupler to show the first and second magnets therein;

FIG. 5 is a partial side sectional view of the mounting system with the socket of the personal navigation device coupled to the mounting coupler; and

FIG. 6 is a partial side sectional view of the mounting system with the socket of the personal navigation device separated from the mounting coupler.

The drawing figures do not limit the present technology to the specific embodiments disclosed and described herein. The drawings are not necessarily to scale, emphasis instead being placed upon clearly illustrating the principles of the technology.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Embodiments of the present technology relate to a mounting system for mounting a personal navigation device to a surface. Electronic devices with navigational capabilities such as cell phones, smart phones, tablets, handheld global positioning system (GPS) devices, and the like are widely used. Typically, a user will carry such a personal navigation device with him or store it when he is not using it for vehicle navigation. Then, when needed for vehicle navigation, the user will retrieve the personal navigation device and mount it to the vehicle's dashboard or windshield. Often, the personal navigation device is mounted with a mounting system that includes a base assembly which sits on the dashboard or couples to the windshield. The mount may also include a mounting coupler in which the personal navigation device is placed and held such that the contacts of a communication port on the personal navigation device line up and mate with the contacts of an electrical connector on the mounting coupler. This placement requires a particular orientation of the personal navigation device and some precision in aligning the personal navigation device with the mounting coupler which can be tedious and time consuming. Embodiments of the present technology provide a mounting system that allows a user to quickly and easily attach the personal navigation device to the mounting coupler so that the personal navigation device is properly oriented and the electrical connector of the mounting coupler mates with the communication port of the personal navigation device. Such configurations enable the personal navigation device to be supported by the mounting system without reliance on ledges or other physical supports that may obstruct installation and use of the navigation device.

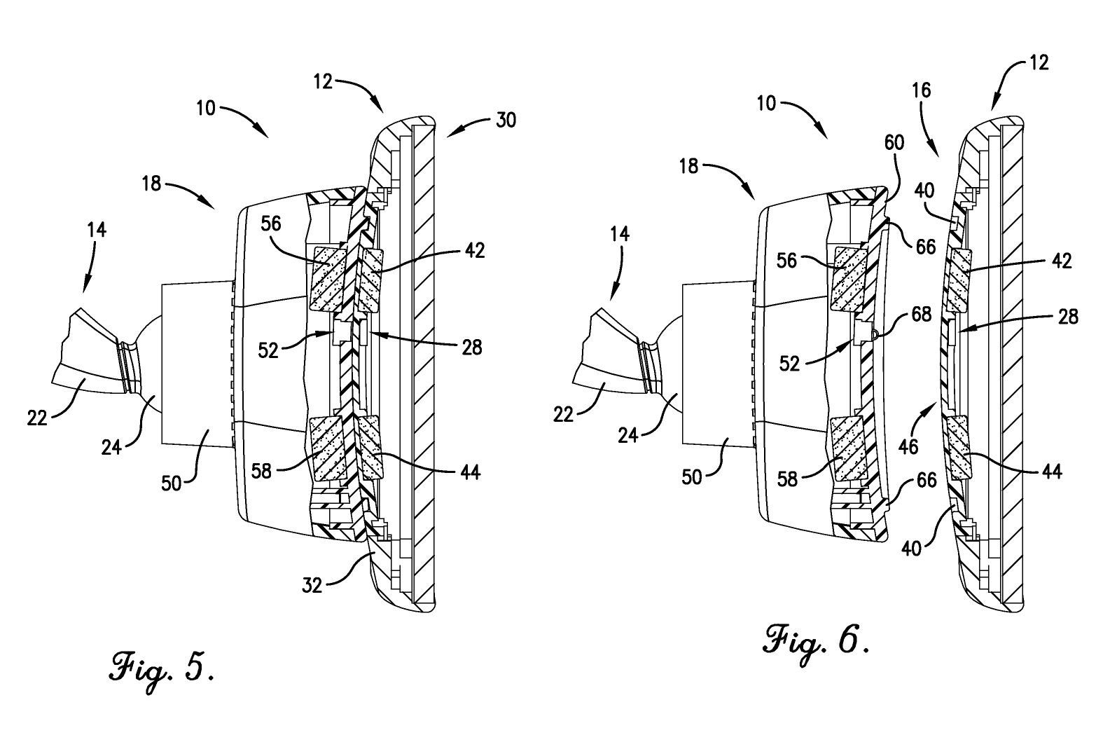

Embodiments of the technology will now be described in more detail with reference to the drawing figures. Referring initially to FIGS. 1-6, a mounting system 10 is illustrated which supports a personal navigation device 12 on a surface and that ensures proper orientation and registration. The mounting system 10 broadly comprises a base assembly 14, a socket 16, and a mounting coupler 18.

The base assembly 14, best seen in FIGS. 1-4, generally attaches or otherwise supports the mounting system 10 to a surface in the vehicle. The surface may be an upper or forward surface of a dashboard, an inner surface of a windshield, a lid of a storage compartment, or any other suitable mounting surface. In some embodiments, the base assembly 14 may rigidly attach to the surface, while in other embodiments, the base assembly 14 may removably attach to the surface or even just rest on the surface. In various embodiments, the base assembly 14 includes a base 20, an arm 22, and a mounting ball 24.

The base 20 may be any component capable of supporting the personal navigation device on the mounting surface and may include fasteners, fittings, couplings, connectors, adapters, weights, or the like, or combinations thereof that are configured to attach to or frictionally engage the interior surface of the vehicle. The arm 22 may be generally elongated with opposing first and second ends. The first end may attach to the base 20, while the second end may attach to the mounting ball 24. An exemplary base assembly 14 is described in U.S. Pat. No. 7,475,858, issued Jan. 13, 2009, U.S. Pat. No. 7,516,928, issued Apr. 14, 2009, and U.S. Pat. No. 8,120,895, issued Feb. 21, 2012, all of which are incorporated by reference herein in their entirety.

The personal navigation device 12 may include any electronic device with navigational capabilities such as a cell phone, a smart phone, a tablet, a GPS device, a GLONASS device, a Galileo device, and the like. Typically, the personal navigation device 12 is sized so that it is handheld and portable. Along with appropriate electronic components, the personal navigation device 12 may include a housing 26, a communication port 28, and the socket 16. The housing 26 may include a forward wall 30, a rear wall 32, and four sidewalls 34. The forward wall 30 may include a display 36 with a touchscreen or similar user interface such as a keypad or keyboard, pushbuttons, or the like. The sidewalls 34 may include switches, pushbuttons, or other interface components. The sidewalls 34 may further include secondary communication ports or power or charging ports that receive cables, wires, or other conductive connectors.

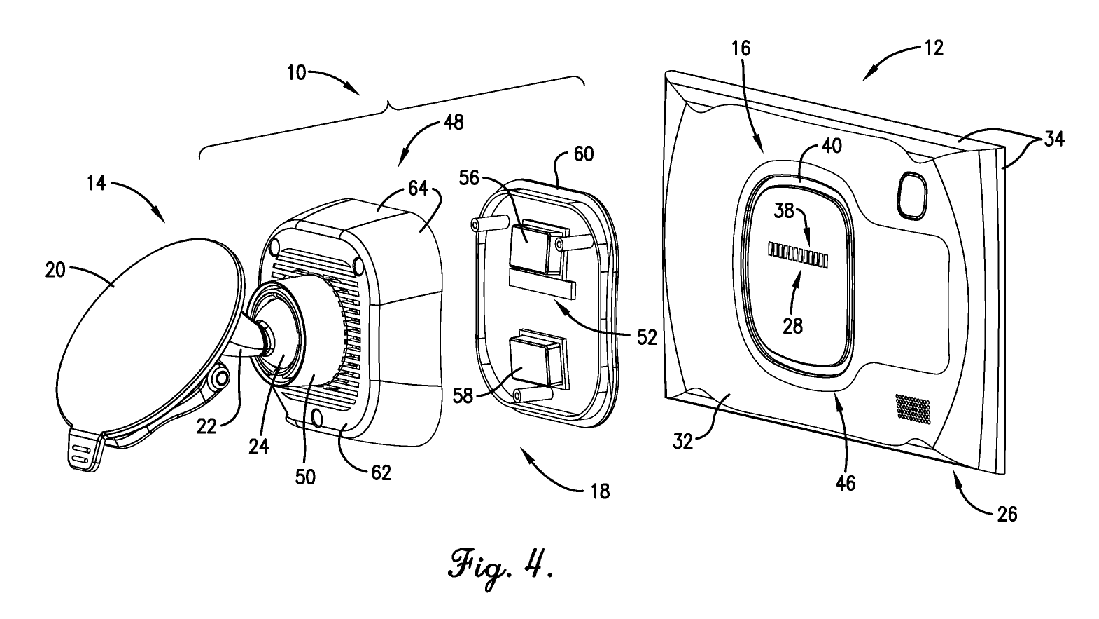

The communication port 28, seen in FIGS. 4-6, generally allows the personal navigation device 12 to receive electronic signals and/or electrical power while it is mounted to the mounting system 10. The communication port 28 may include a plurality of openings 38 that are positioned on the rear wall 32. Typically, the openings 38 are linearly aligned and uniformly spaced apart. But, in other configurations, the openings 38 may present any configuration or orientation. In proximity to the openings 38 and internal to the personal navigation device 12 are positioned a plurality of metal contacts, which may be coupled to electrical or electronic circuits of the personal navigation device 12.

The socket 16, seen in FIGS. 4 and 6, couples the personal navigation device 12 to the mounting system 10 and may include a channel 40, a first magnet 42, a second magnet 44, and a mounting surface 46. The channel 40 may be inset in an outer surface of the rear wall 32 of the housing 26. The channel 40 and the area of the rear wall 32 therewithin form the mounting surface 46, which contacts the mounting coupler 18 when the personal navigation device 12 is attached to the mounting coupler 18. The channel 40 may be roughly centered both horizontally and vertically on the rear wall 32. In various embodiments, the channel 40 includes four sides with rounded corners therebetween to ensure proper registration of the mounting coupler 18. Furthermore, the rear wall 32 may have an outward curvature, or a convex shape, along one axis to aid in the attachment of the personal navigation device 12 to the mounting coupler 18 as explained in more detail below. In various embodiments, the rear wall 32 is curved along the horizontal axis, such that the middle of the rear wall 32 protrudes outward more so than the top and bottom edges. In addition, the communication port 28 may be positioned within the area defined by the channel 40 on the rear wall 32.

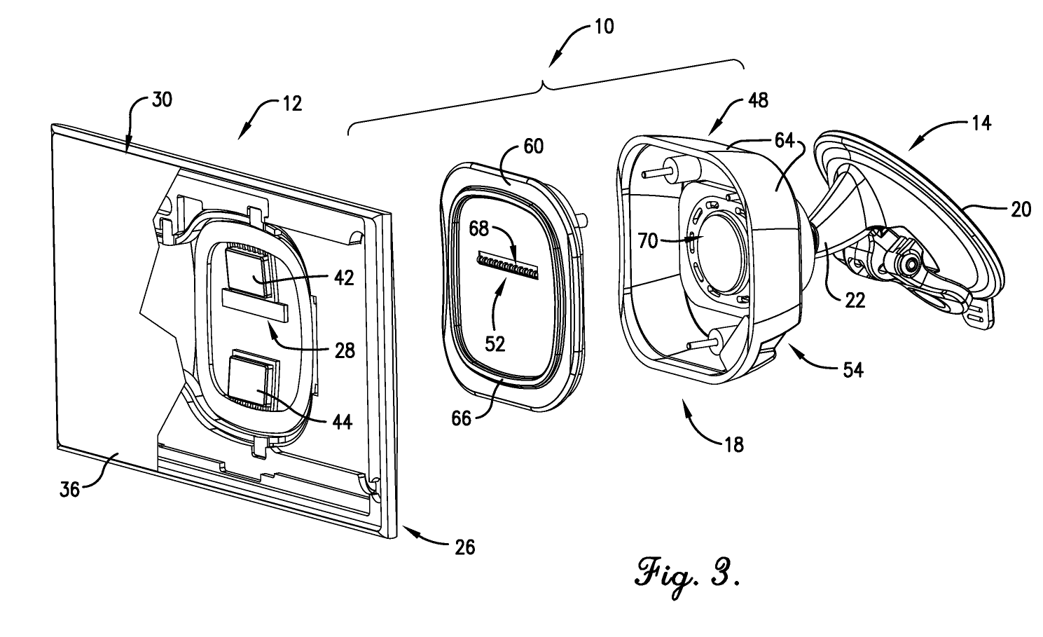

The first magnet 42 and the second magnet 44, seen in FIGS. 3 and 5-6, generally ensure the proper orientation of the personal navigation device 12 with the mounting coupler 18 and provide an attractive force between the personal navigation device 12 and the mounting coupler 18 such that the mounting coupler 18 is able to retain the personal navigation device 12 securely while the vehicle is traveling. Exemplary magnets 42, 44 may have dimensions of approximately 1.5 centimeters (cm) by approximately 1 cm by approximately 0.35 cm. The magnets 42, 44 may be mounted to an inner surface of the rear wall 32 and positioned within the boundary of the channel 40. Exemplary magnets 42, 44 may be spaced approximately 1.25 cm from one another. The magnets 42, 44 may be oriented such that their polar axes are normal to the inner and outer surfaces of the socket 16. Furthermore, the first magnet 42 may be oriented such that its poles oppose the poles of the second magnet 44. For example, the north pole of the first magnet 42 may be positioned adjacent to the socket 16, while the south pole of the second magnet 44 is positioned adjacent to the socket 16, or vice-versa.

The mounting coupler 18 removably attaches to the socket 16 and may include a body 48, a ball socket 50, an electrical connector 52, a cable port 54, a first magnet 56, and a second magnet 58. The body 48 may include a forward wall 60, a rear wall 62, and four sidewalls 64. The forward wall 60 may include an outer surface which contacts the mounting surface 46 of the socket 16. Accordingly, the forward wall 60 may have an inward curvature, or concave shape, that is complementary to the outward curvature of the rear wall 32 of the personal navigation device housing 26. Thus, in various embodiments, the forward wall 60 is curved along the horizontal axis, such that the middle of the forward wall 60 curves inward from the top and bottom edges. The forward wall 60 may further include a ridge 66 on the outer surface thereof.

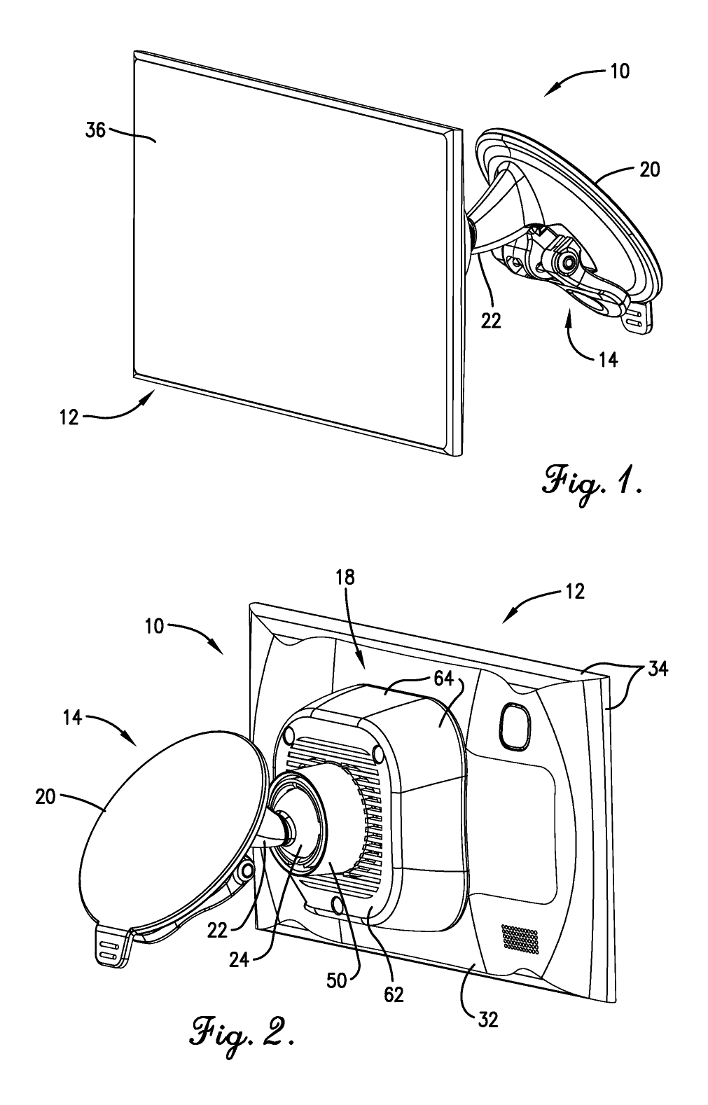

The ball socket 50, seen in FIGS. 2 and 4-6, removably couples the mounting coupler 18 to the base assembly 14 and is generally positioned on or in the rear wall 62 of the body 48. The ball socket 50 may include a spherical opening that is configured to receive the mounting ball 24, such that the mounting ball 24 fits within the ball socket 50. An exemplary ball socket 50 is described in U.S. Pat. No. 7,475,858, U.S. Pat. No. 7,516,928, and U.S. Pat. No. 8,120,895, all of which are incorporated by reference herein in their entirety. Furthermore, the ball socket 50 may allow the mounting coupler 18 to rotate or pivot with respect to the base assembly 14 about three orthogonal axes, such as the X, Y, and Z axes.

The ridge 66, seen in FIGS. 3 and 6, may protrude outward from the outer surface of the forward wall 60 and generally fits into the channel 40 of the socket 16 when the personal navigation device 12 is mounted to the mounting coupler 18. Accordingly, the ridge 66 may have a height to match the depth of the channel 40 and a shape to match the shape of the channel 40. Hence, in various embodiments, the ridge 66 includes four sides with rounded corners therebetween.

The electrical connector 52, seen in FIGS. 3 and 5-6, generally mates with the communication port 28 of the personal navigation device 12 and may be positioned on the forward wall 60 within the area defined by the ridge 66. The electrical connector 52 may include a plurality of electrical contact pins 68 that protrude outward from linearly aligned and evenly spaced openings on the forward wall 60. When the personal navigation device 12 is mounted to the mounting coupler 18, the electrical contact pins 68 extend through the openings 38 of the communication port 28 and touch the electrical contacts thereof.

The cable port 54, seen in FIG. 3, may be positioned along the sidewalls 64 of the body 48 and may receive a cable that provides electronic signals and electrical power. The cable may include a plurality of metal conductors and a connector such as a universal serial bus (USB) type connector. Thus, the cable port 54 may be configured to receive such a connector. The cable port 54 may further be internally electrically connected to the electrical connector 52.

The first magnet 56 and the second magnet 58, seen in FIGS. 4-6, generally function in concert with the first and second magnets 42, 44 of the personal navigation device socket 16 to ensure the proper orientation of the personal navigation device 12 with the mounting coupler 18 and provide the attractive force between the personal navigation device 12 and the mounting coupler 18. Exemplary magnets 56, 58 may have the same dimensions (approximately 1.5 cm by approximately 1 cm by approximately 0.6 cm) and the same spacing therebetween (approximately 1.5 cm) as the first and second magnets 42, 44 of the personal navigation device 12. The first and second magnets 56, 58 may be mounted to an inner surface of the forward wall 60 and positioned within the boundary of the ridge 66. The magnets 56, 58 may also be mounted such that their polar axes are normal to the inner and outer surfaces of the forward wall 60. In addition, the first magnet 56 may be positioned on the forward wall 60 such that it aligns with the first magnet 42 of the personal navigation device 12 when the personal navigation device 12 is mounted to the mounting coupler 18. The second magnet 58 may be similarly aligned with the second magnet 44. Furthermore, the magnets 42, 44, 56, 58 may be oriented such that the opposing poles of the first magnets 42, 56 face one another and the opposing poles of the second magnets 44, 58 face one another, thereby creating a force of attraction between the corresponding magnets 42, 44, 56, 58. For example, the south pole of the first magnet 56 may face the north pole of the first magnet 42 and the north pole of the second magnet 58 may face the south pole of the second magnet 44. Given the placement of the magnets 42, 44, 56, 58 as described, the personal navigation device 12 may couple with the mounting coupler 18 in only one orientation—with the first magnet 42 aligned with the first magnet 56 and the second magnet 44 aligned with the second magnet 58. Any other orientation is opposed by repelling magnetic fields.

In various embodiments, the magnets 56, 58 of the mounting coupler 18 may have an exemplary magnetic surface strength of about 3800 gauss, while the magnets 42, 44 of the personal navigation device 12 have a relatively smaller exemplary magnetic surface strength of about 3500 gauss. With this configuration, a strong force of attraction between the personal navigation device 12 and the mounting coupler 18 exists, as provided primarily by the magnets 56, 58 of the mounting coupler 18. But, the configuration also allows the personal navigation device 12, with relatively weaker magnets, to be carried in purses, backpacks, pockets, luggage, and the like without interfering with other nearby electronic devices.

In some embodiments, the mounting coupler 18 further includes a speaker 70, seen in FIG. 3, positioned in the interior of the body 48 adjacent to the rear wall 62. The speaker 70 may include drivers, transducers, or the like, as are known in the art. The speaker 70 may be electrically coupled to the electrical connector 52, through which the speaker 70 may receive an audio signal from the personal navigation device 12.

The mounting system 10 may function as follows. The base assembly 14 may be attached to the interior surface of the vehicle in a conventional manner. In some embodiments, the base assembly 14 may be positioned on the upper or forward surface of the dashboard. In other embodiments, the base assembly 14 may be attached to the inner surface of the windshield. The mounting coupler 18 may be attached to the base assembly 14 such that the mounting ball 24 is inserted into the ball socket 50. A first end of a cable may be connected to the cable port 54 of the mounting coupler 18. A second end of the cable may connected to a cigarette lighter adapter or a battery power adapter within the interior of the vehicle.

A user may then bring the personal navigation device 12 in proximity to the mounting coupler 18. Generally, the rear wall 32 of the personal navigation device 12 faces the forward wall 60 of the mounting coupler 18. When the personal navigation device 12 gets close enough to the mounting coupler 18, the magnets 42, 44 of the personal navigation device 12 and the magnets 56, 58 of the mounting coupler 18 attract one another, and the personal navigation device 12 is pulled onto the mounting coupler 18, as seen in FIGS. 1-2 and 5. At this point, the socket 16 of the personal navigation device 12 contacts the forward wall 30 of the mounting coupler 18, and the electrical connector 52 of the mounting coupler 18 electrically couples with the communication port 28 of the personal navigation device 12. Thus, the personal navigation device 12 may receive electrical power and signals from the cable that is connected to the cable port 54 of the mounting coupler 18.

Given the magnetic field strength of the magnets 42, 44, 56, 58, the personal navigation device 12 may be retained by the mounting coupler 18 with sufficient force to maintain a reliable electrical connection between the electrical connector 52 and the communication port 28 while the vehicle is in motion and encountering bumps or uneven roadway surfaces that would tend to separate the personal navigation device 12 from the mounting coupler 18. Furthermore, the alignment of the magnets 42, 44, 56, 58 and the fitting of the ridge 66 within the channel 40 ensure the proper registration and alignment of the electrical connector 52 and the communication port 28. In addition, care need not be taken in orienting the personal navigation device 12 with respect to the mounting coupler 18 because the magnets 42, 44, 56, 58 automatically rotate the personal navigation device 12 to the proper orientation. If the personal navigation device 12 is far off from the proper orientation, or even inverted, when the user tries to mount the personal navigation device 12 to the mounting coupler 18, then the magnets 42, 44 of the personal navigation device 12 and the magnets 56, 58 of the mounting coupler 18 repel one another, preventing improper mounting.

Once the personal navigation device 12 is attached to the mounting coupler 18, the viewing angle between the driver and the display 36 may be adjusted by rotating the personal navigation device 12 to the proper position. The ball socket 50 of the mounting coupler 18 may rotate with respect to the mounting ball 24 of the base assembly 14, thereby allowing the personal navigation device 12 to rotate as well. When the user wishes to unmount the personal navigation device 12 from the mounting coupler 18, he simply has to hold the personal navigation device 12 and pull it until the pulling force overcomes the attracting force of the magnets 42, 44, 56, 58.

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

What is claimed is:

1. A mounting coupler for removably mounting a personal navigation device to a base assembly, the mounting coupler comprising:
a body with a forward wall configured to couple with the personal navigation device and a rear wall configured to couple with the base assembly; and
spaced apart first and second magnets positioned adjacent to an inner surface of the forward wall and oriented such that the poles of the first magnet oppose the poles of the second magnet and the poles of both magnets are normal to the inner surface of the forward wall to ensure proper orientation of the personal navigation device on the mounting coupler.

2. The mounting coupler of claim 1, further comprising an electrical connector positioned in the forward wall and a cable port electrically coupled to the electrical connector and configured to receive an electrical cable such that electrical connection is provided between the electrical cable and the electrical connector.

3. The mounting coupler of claim 1, wherein the forward wall includes an outward protruding ridge configured to couple with a complementary channel on the personal navigation device to assist with registry of the personal navigation device on the mounting coupler.

4. The mounting coupler of claim 3, wherein the ridge includes four sides with rounded corners therebetween.

5. The mounting coupler of claim 1, wherein the forward wall of the coupler body includes an inward curvature along only one axis.

6. The mounting coupler of claim 1, wherein the rear wall of the coupler body includes a ball socket.

7. A mounting system for mounting a personal navigation device to a surface, the mounting system comprising:
a base assembly comprising:
a base,
a mounting ball, and
an arm connecting the mounting ball to the base;
a socket configured to be integrated in the personal navigation device, the socket comprising:
a mounting surface, and
spaced apart first and second magnets positioned opposite the mounting surface and oriented such that the poles of the first magnet oppose the poles of the second magnet; and
a mounting coupler operable to attach to the mounting ball of the base assembly and removably couple with the socket of the personal navigation device, the mounting coupler comprising:
a body with a forward wall configured to couple with the personal navigation device and a rear wall configured to couple with the base assembly, and
spaced apart first and second magnets positioned adjacent to an inner surface of the forward wall and oriented such that the first magnet of the mounting coupler attracts the first magnet of the socket and repels the second magnet of the socket and the second magnet of the mounting coupler attracts the second magnet of the socket and repels the first magnet of the socket to ensure proper orientation of the personal navigation device on the mounting coupler.

8. The system of claim 7, wherein the forward wall of the mounting coupler body includes an electrical connector.

9. The system of claim 8, wherein the mounting coupler body further includes a cable port configured to receive an electrical cable such that electrical connection is provided between the cable and the connector.

10. The system of claim 8, wherein the socket further includes a communication port that electrically couples with the electrical connector when the personal navigation device couples with the mounting coupler.

11. The system of claim 7, wherein the forward wall of the mounting coupler body includes an outward protruding ridge positioned adjacent to the perimeter thereof and the socket includes a channel complementary to the ridge such that when the personal navigation device is coupled to the mounting coupler, the ridge fits into the channel.

12. The system of claim 11, wherein the ridge and the channel each include four sides with rounded corners therebetween.

13. The system of claim 7, wherein the forward wall of the mounting coupler body includes an inward curvature along only one axis.

14. A personal navigation system comprising:
a personal navigation device having a housing with a socket integrated therein, the socket comprising:
a mounting surface, and
spaced apart first and second magnets positioned opposite the mounting surface and oriented such that the poles of the first magnet oppose the poles of the second magnet; and
a mounting system for mounting the personal navigation device to a surface of a vehicle, the mounting system comprising:
a base assembly comprising:
a base,
a mounting ball, and
an arm connecting the mounting ball to the base,
a mounting coupler that attaches to the mounting ball of the base assembly and removably couples with the socket of the personal navigation device, the mounting coupler comprising:
a body with a forward wall configured to couple with the personal navigation device and a rear wall configured to couple with the base assembly, and
spaced apart first and second magnets positioned adjacent to an inner surface of the forward wall and oriented such that the first magnet of the mounting coupler attracts the first magnet of the socket and repels the second magnet of the socket and the second magnet of the mounting coupler attracts the second magnet of the socket and repels the first magnet of the socket to ensure proper orientation of the personal navigation device on the mounting coupler.

15. The system of claim 14, wherein the mounting surface of the socket includes a communication port and the forward wall of the mounting coupler body includes an electrical connector such that when the personal navigation device is coupled to the mounting coupler, the communication port electrically communicates with the electrical connector.

16. The system of claim 15, wherein the mounting coupler body further includes a cable port configured to receive an electrical cable such that electrical connection is provided from the cable to the communication port through the electrical connector.

17. The system of claim 14, wherein the socket includes a channel and the forward wall of the mounting coupler body includes a ridge such that when the personal navigation device is coupled to the mounting coupler, the ridge fits into the channel.

18. The system of claim 17, wherein the ridge and the channel each include four sides with rounded corners therebetween.

19. The system of claim 14, wherein the socket includes an outward curvature along only one axis and the forward wall of the mounting coupler body includes an inward curvature along the same axis.
